(19) United States
(12) Patent Application Publication
(10) Pub. No.: US 2009/0271324 A1
(43) Pub. Date: Oct. 29, 2009

(54) SYSTEMS AND METHODS FOR METERED SOFTWARE AS A SERVICE

(75) Inventors: Divakar Jandhyala, Austin, TX (US); Ranjit Nayak, Austin, TX (US); Yuqi Qiao, Austin, TX (US); Matthew Kinman, Austin, TX (US)

Correspondence Address: ROPES & GRAY LLP, PATENT DOCKETING 39/361, 1211 AVENUE OF THE AMERICAS, NEW YORK, NY, 10036-8704, US

(73) Assignee: eVapt, Inc., Austin, TX (US)

(21) Appl. No.: 12/435,680

(22) Filed: May 5, 2009

Related U.S. Application Data
(63) Continuation-in-part of application No. 11/890,874, filed on Aug. 8, 2007.
(60) Provisional application No. 61/127,264, filed on May 12, 2008.
(60) Provisional application No. 61/127,263, filed on May 12, 2008.
(60) Provisional application No. 60/836,982, filed on Aug. 11, 2006.

(51) Int. Cl. G06Q 30/00; G06Q 50/00; G06Q 20/00; G06Q 10/00

(52) U.S. Cl. 705/80; 705/34; 705/26; 705/7

(57) ABSTRACT

Systems and methods are provided for facilitating software as a service (SAAS) by receiving information of SAAS offerings and metrics for tracking a users use of the SAAS offerings. The systems may be used to create SAAS orders and provide compliance and auditing of the SAAS, as well as generating invoices and receiving payment for the SAAS.

### CROSS REFERENCE TO RELATED APPLICATIONS

This application claims priority to provisional application Ser. No. 61/127,264, filed on May 12, 2008 and titled Standards Based Metering Data Repository for Software as a Service, and provisional application Ser. No. 61/127,263, filed on May 12, 2008 and titled Pricing, Billing and Invoicing for Software as a Service Utilizing a Metering Service. This application is a continuation in part of application Ser. No. 11/890,874, titled Generic Software Service Meter, which claims priority to provisional patent application 60/836,982, filed Aug. 11, 2006. The entire contents of the above-referenced applications are hereby incorporated by reference.

### FIELD OF THE INVENTION

Embodiments of the invention relate to systems and methods for metering software as a service (SAAS) and providing one or more supporting services thereto.

### BACKGROUND OF THE INVENTION

Historically, software has been provided to customers as packaged software. Such software packages were typically licensed and offered to one or more end users to use the software with one or more computers, portable devices, or other devices. Software licenses were typically an all-inclusive license that were limited or restricted by the number of devices with which the software could be used and or the numbers of users of the software. Use of the software within these restrictions was typically not measured or limited.

More recently software has been delivered via software as a service (SAAS). The SAAS model is typically that a software vendor runs a software application and provides access to the application to a user over a network, such as the internet. The users pay for the service, generally, on a monthly or other periodic basis. Some of the advantages of SAAS from a user's perspective are that the software need not be locally installed on a computer or local network, thereby reducing hardware requirements, and the software need not be maintained, upgraded, or supported by users. From the vendor's perspective, hosting software can provide a way to protect the intellectual property as well as provide an ongoing stream of revenue for the service.

Conventional SAAS delivery, however, has been hampered by a lack of a single multifunctional metering and billing system that can be applied to any type of software service and customized for varied types of subscriptions and use requirements. Embodiments described herein are designed to overcome shortcomings of conventional systems and methods for supporting and delivering SAAS. SUMMARY OF THE INVENTION

Embodiments of the invention may be adapted to provide to users and providers of SAAS meters and auxiliary services, including, among other things, usage tracking, service offer models, fees and pricing calculations, service order monitoring, customer billing and invoicing, usage metrics and analytics, and other services. Embodiments of the invention may be configured using one or more modules that may be adapted to integrate with typical computer network architectures, various end user scenarios, as well as varying types of software services, that may have varying types of measurable units.

Some of the features of embodiments of the invention include: metering software usage, providing a utility module for SAAS, providing a billing module for SAAS, and customizable metering and billing modules.

In an embodiment of the invention, a system is provided for facilitating software as a service (SAAS) that includes a computer communicatively coupled to a network, at least one SAAS provider, and at least one SAAS user, wherein the SAAS providers comprise an observer. The computer is configured to receive data indicating an SAAS offering and a metric associated with the SAAS offering, and receive a user selection indicating one of the SAAS offerings and a metric associated with the SAAS offerings. The computer monitors use, using the observer, based on the selected metric, by the user of the selected SAAS offering. Based at least in part on the user's use of the SAAS offering, the computer generates a periodic invoice.

Some other embodiments include features such as automated order generation based on the SAAS offerings, certain metrics and user selections. Auditing and compliance with the order terms may also be provided based on the SAAS offering and monitored use. The orders, compliance and auditing may be dynamically updated based on changes in selected metrics.

In some embodiments, payment facilities are provided for paying invoices for the SAAS offerings.

In some embodiments, the monitored use of the SAAS offerings may be used to identify inefficiencies in orders, or opportunities for enhanced service packages.

### BRIEF DESCRIPTION OF THE DRAWINGS

The above and other advantages of the invention will be apparent upon consideration of the following detailed description, taken in conjunction with accompanying drawings, in which like reference characters refer to like parts throughout, and in which:

FIG. 1 depicts an illustrative network for providing SAAS according to an embodiment of the invention.

FIG. 2 depicts a graphical representation of an account manager for an SAAS provider and user according to an embodiment of the invention.

FIG. 3 depicts a graphical representation of the account manager interface for editing a metric according to an embodiment of the invention.

FIG. 4 depicts a graphical representation of SAAS pricing interface according to an embodiment of the invention.

FIG. 5 depicts a graphical representation of an invoice according to an embodiment of the invention.

FIG. 6 depicts a flowchart of a process for facilitating provision of SAAS according to an embodiment of the invention.

### DETAILED DESCRIPTION

Embodiments of the invention relate to metering and providing supporting services for software as a service (SAAS). The metering and support services are typically provided using one or more modules that may be provided as its own SAAS that may be remotely deployed and delivered, or locally downloaded and integrated by an SAAS vendor. Some embodiments of the invention are designed to be used by SAAS users so that the SAAS user can track and analyze SAAS usage. Embodiments of the invention may also be used in respect of conventional software use arrangements, other than SAAS, as would be understood by one of skill in the art.

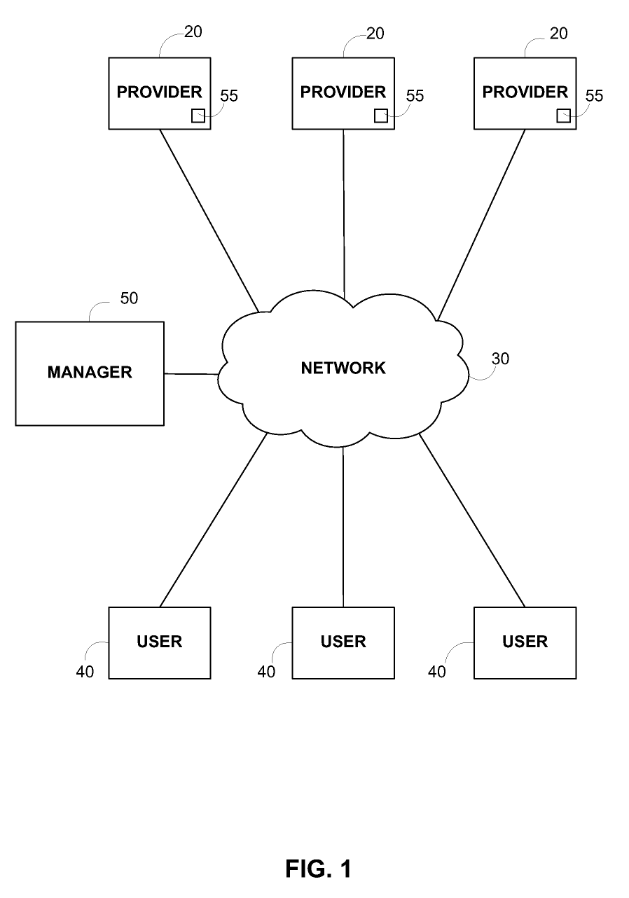

Embodiments of the invention may be provided according to the system diagram depicted in FIG. 1. As shown, one or more SAAS providers 20 may be communicatively coupled via network 30 to one or more users 40. An SAAS Manager 50 may also be communicatively coupled via the network 30 to the one or more SAAS providers 20 and/or users 40. The one or more SAAS providers 20 can be one or more separate providers or vendors of SAAS. Types of SAAS may include, for example: electronic mail, conferencing, accounting, information technology support, human resources, project management, or other services. Embodiments of the invention may be designed to operate in conjunction with a plurality of types of software as a service. Embodiments of the invention may be customized as described herein to support any type or combination of SAAS.

Network 30 may be any communication link or links, such as the internet, wide area network, local area network, or other network, capable of providing information and data communication between providers 20, users 40 and manager 50. The users 40 may be any type of user of SAAS, for example, users that range from an individual software user with a single computing device to a small enterprise having several computing devices to a large organization supporting many computing devices. In addition, each user 40 may use one or more different types of SAAS provided by more than one provider 20.

The SAAS Manager 50 comprises software deployed on a system that may include one or more processing components coupled to one or more data storage components, computer servers and other components that may be configured to support the functionality described herein. Manager 50 is designed to provide management functions for SAAS providers 40 using one or more modules. The SAAS Manager 50 modules may include: package pricing, billing, invoicing, usage metering, analytics, customer service, orders management, compliance, and others. The SAAS Manager 50 may be provided using one or more combinations of software modules, as further described herein. In addition, SAAS Manager 50 may communicate with an observer software component 55 that is deployed at the SAAS provider 20 that provides information to SAAS Manager 50 for SAAS use measurement, as will be further described herein.

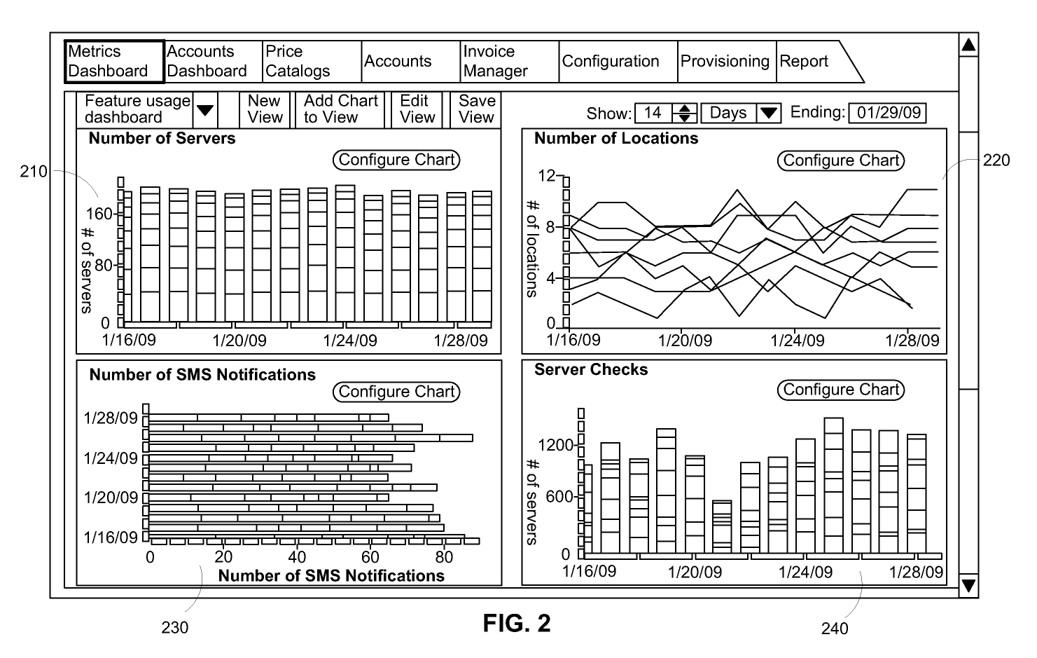

Some of the modules and services provided by SAAS Manager 50 are explained in further detail with reference to FIGS. 2-6. The modules discussed herein may be delivered as SAAS to the providers 40 and users 20 or distributed remotely, or installed locally for an SAAS provider 20 or other user 40. The modules provided by the SAAS Manager 50 may be used to support metering of use of SAAS by user 40 of SAAS provider's 20 services.

Turning to FIG. 2, an exemplary module may be provided via a usage table such as a dashboard or manager interface for SAAS providers 20 or users 40. The usage table as shown in FIG. 2 typically includes a dashboard or other display that may be used to depict data, such as SAAS usage information, on a daily, weekly, hourly, or other periodic interval. As shown in the usage table in diagrams 210-240, use of SAAS may be depicted based on metered data, such as a number of servers 210, number of locations 220, number of SMS notifications 230, number of sensor checks 240, or other measured use basis, by customer, group of customers, or other unit of measure. Other types of SAAS uses and units of measure or metrics may also be monitored and graphically depicted in a dashboard as shown in FIG. 2.

Embodiments of the dashboard may be customized by the user, for example, certain types of uses may be viewed, the periodic interval may be defined, one or more customers may be selected, order types correlated in the graphic, and other features. A user of the SAAS manager dashboard may be either the SAAS provider 20 or SAAS user 40. From the perspective of an SAAS provider 20, the dashboard would be typically used to meter usage for example, for billing purposes, or to identify opportunities for selling enhanced packages, etc. For an SAAS user 40, the dashboard could be used to meter usage with respect to compliance with service limits, with a view to minimize use and costs, etc. A graphical depiction of metered data provides an SAAS provider 20 with easily understood customer data which enhances an SAAS provider's 20 ability to monitor usage, check for order compliance, provide product enhancements, suggest order or package upgrades, etc. For example, a sales representative may view a user's monthly use of a certain feature and suggest a new SAAS package to the user that allows greater use of the feature. A product manager may view the same data and prioritize development of other supporting features. Finance departments may view the data to ensure that customers or users are within order or package limits. In addition, a SAAS user may also use the graphical analysis to monitor their own usage to ensure that their use is appropriate given their package, as well as below any package limitations.

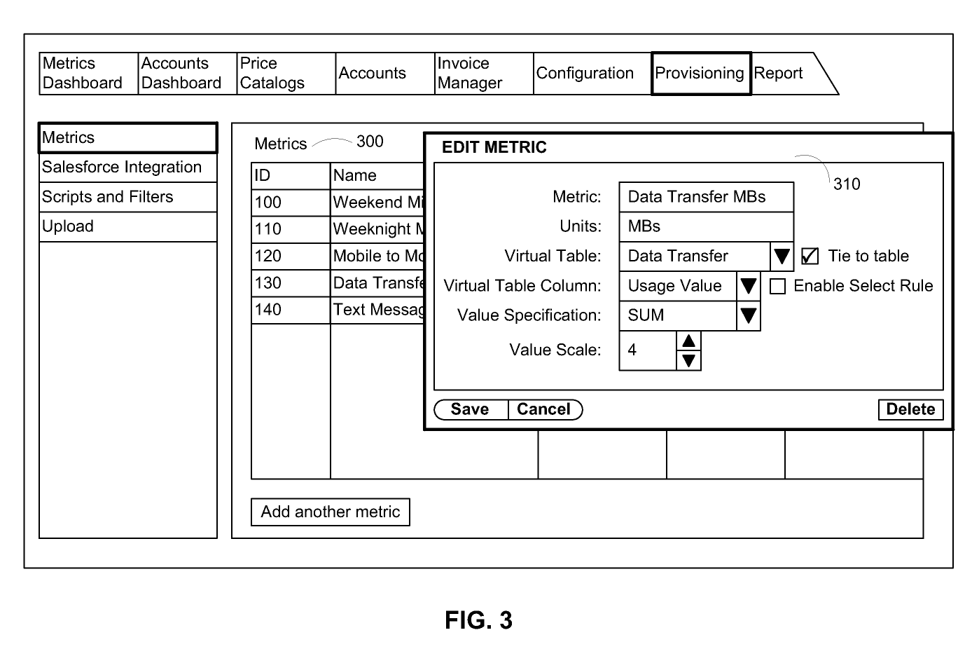

Turning to FIG. 3, from the account manager interface or dashboard, an account manager user, including the SAAS provider 20 or user 40, may customize aspects of a software package by editing one or more metrics 300. For example, a user may select one of the metrics 300 which will allow editing of the metric to occur in box 310. As shown, the user may edit the metric units, including scale or magnitude and tie or otherwise associate the metric to a table or source to automate measurement of the metric.

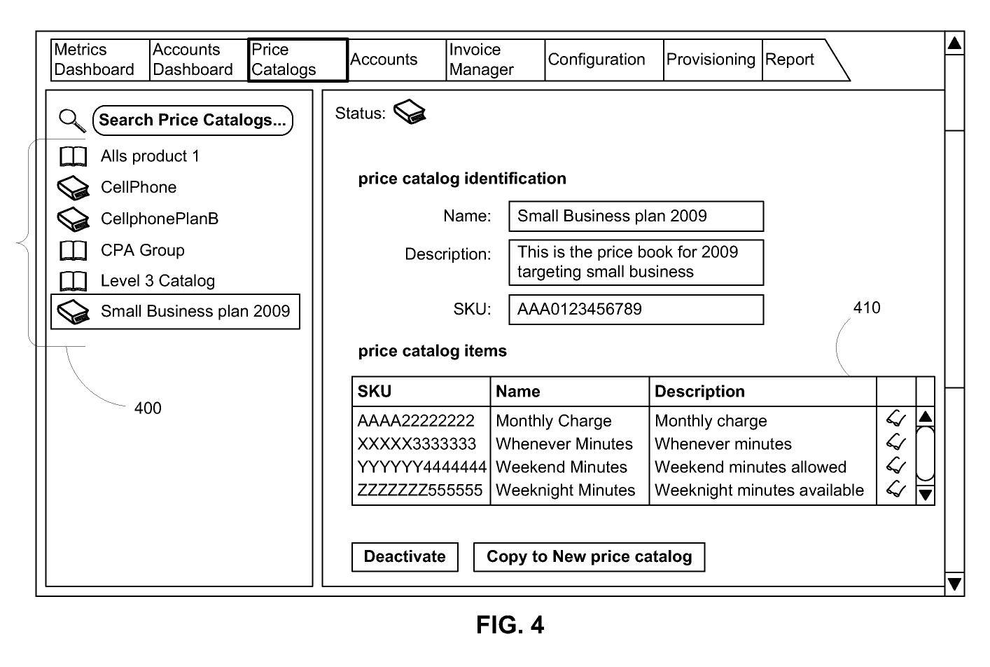

The metrics shown in FIG. 3, or as discussed herein may be used as a basis for customizing certain SAAS package plans. For example, turning to FIG. 4, an SAAS provider 20 may customize software package plans according to one or more parameters. For example, SAAS software packages may have different prices for certain uses of certain features. Each of the package plans 400 may be customizable using various metrics 410 which can be edited, for example (as shown in FIG. 3) by selecting any of the price catalog items. Metric 410 is meant to represent an aspect of an SAAS that can be measured. Typically, SAAS will have one or more metrics which define how the SAAS may be metered. In an example, metrics for an email service may include: number of emails, size of emails sent and email account size. For a web conference service (SAAS) metrics may include data transfer, monthly charges or other metric. As will be understood by one in the art, various features and quantities of use of each feature or metric may also be selected for a price plan. SAAS providers 20 can customize pricing and offerings in any of a number of ways. The metrics included in a price plan may establish ranges of use, upper/lower limits, in addition, metrics in a plan may be dynamic and based on use of a second metric. One exemplary customization scheme may involve SAAS provider 20 registering with Manager system to access an account management application provided by SAAS manager 50 in which the SAAS provider 20 may define its services offered in its SAAS, as well as metrics and pricing for the SAAS.

Order elements for the provision of SAAS may also be entered by an SAAS provider 20 into the SAAS manager module. For example, the SAAS provider 20 may select certain services or offerings to be included in an order for a certain price and term. Finally, SAAS provider 20 may also input or configure data sources for retrieving data or information for measuring an SAAS user's 40 use of the SAAS. The data retrieval from such data sources is typically provided by observer 55.

The information, including pricing, metrics, SAAS offerings, entered into Manager 50 by providers 20 may be consolidated in a database for access by users 40. In embodiments, users 40 are able to select the SAAS offerings via manager 50, including offerings as entered by providers 20 and as compiled by manager 50 in any suitable a la carte or packaged offering.

The SAAS user 40 may access the SAAS manager 50 module using conventional system registration methods and register for SAAS use metering. In an embodiment the SAAS user 40 may purchase the SAAS via the manager 50. In other embodiments, the SAAS user 40 may purchase the SAAS from the SAAS provider 20 directly and each party may use the manager 50 to manage the SAAS use.

In an embodiment, data used to measure SAAS use may be obtained using observer software 55, which may be software deployed behind a SAAS provider's 20 firewall, and that is capable of communicating via network 30 with manager 50 information indicating the SAAS offerings and user's 40 use. The observer 55 is typically configured to include security keys for identification and authorization purposes.

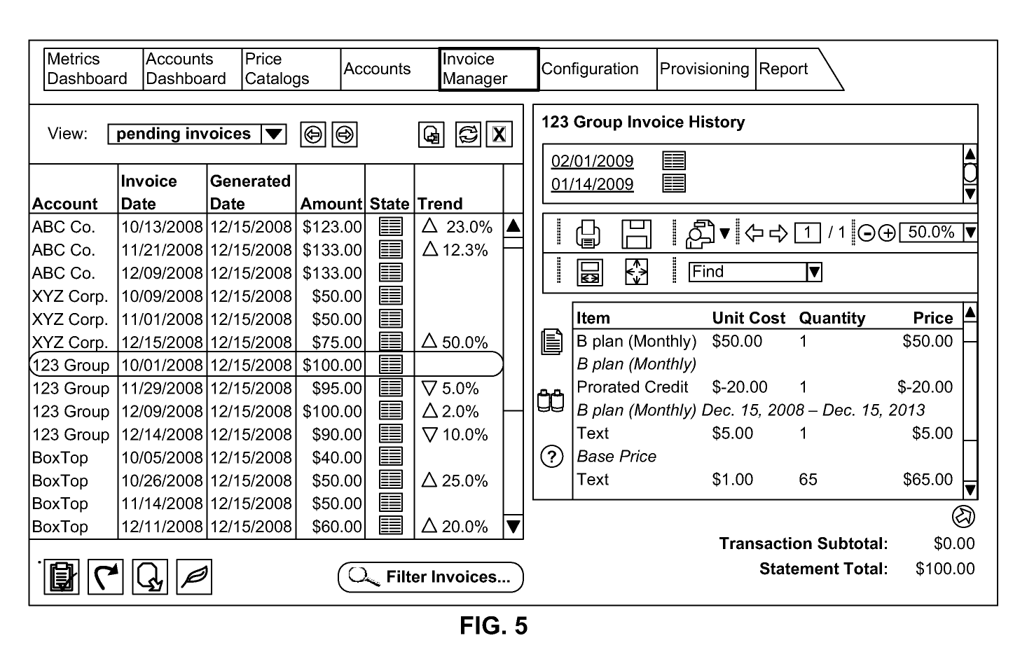

Manager 50 is also configured to provide automated invoicing for SAAS providers 20 and SAAS users 40. Using the metric bases identified by the SAAS provider 20, manager 50 can compare user's 40 monitored use with the specified metrics and prices and generate periodic invoices accordingly. An example of an automated invoice is depicted in FIG. 5 which shows a plurality of accounts, invoice information, as well as analytics, such as trend information indicating use relative to another period.

In addition to generating the invoices, manager 50 may also provide bill payment and collection services. In some embodiments, manager 50 may be configured to temporarily halt access to the SAAS for delinquent payments. In addition, manager 50 may also be configured to provide enhancements, adjustments or discounts to certain users 40 for overpayments, customer loyalty promotions, or other reasons.

Manager 50 may also be configured to provide compliance monitoring and audit features that can track, for example, compliance by providers 20 in providing the SAAS as specified in orders, and auditing the use of SAAS by users 40 to ensure that it is also in compliance with service orders. Compliance monitoring and auditing may be provided by the manager 50 in communication with observers 55.

In an embodiment, manager 50 may be used to identify trends, efficiencies and inefficiencies in user's 40 use of SAAS. More specifically, manager 50 may be used to evaluate the user's 40 use of certain services and measured metrics in order to recommend a change in subscription packages or payment plans. Such information may be useful from the providers 20 perspective, as well as the user's 40 perspective. Such evaluation would involve the manager 50 comparing user's 40 use of SAAS against the SAAS provider's other packages or payment plans, against competitor SAAS provider prices, or other basis. In some embodiments, manager 50 may recommend to the user 40 and/or the provider 20 that the user 40 change to or may be suitable for another a subscription package.

Manager 50 may also be used by SAAS provider 20 to identify users that may be appropriate for certain upselling of added value features or subscription packages provided by the SAAS provider 20 or another complementary provider. For example, provider 20 may identify users that are near or exceeding an upper limit for use of a feature of a pricing plan, or users whose use of features is consistently below certain thresholds that may be more appropriate for another lower priced plan. Manager 50 may also be used to bundle SAAS provided by separate SAAS providers 20.

SAAS use data may be used by manager 50 to provide reporting and data mining for users 40, providers 20 or other entity. For example, manager 50 may be configured to generate periodic SAAS use reports and forecast use trends.

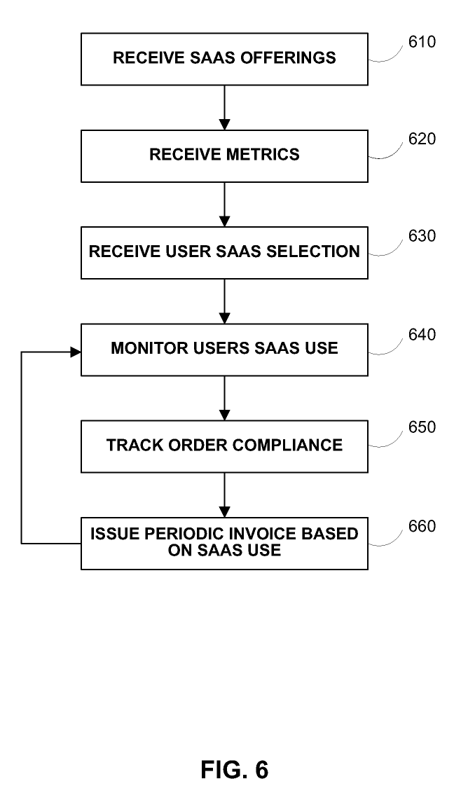

In an embodiment, manager 50 may facilitate the process depicted in the flowchart of FIG. 6. As shown, SAAS offering information may be received by manager 50 at step 610. As discussed previously, the SAAS offering information is typically supplied by a provider 20, and may include any type of software as a service offering. Such offering information may be stored in a manager 50 memory or database which may be accessed by a user 40 when selecting products for purchase. The offering information is also stored in association with metric information received at step 620. Metric information is typically entered by the SAAS provider 20 (for example via metric editing in the screen depicted in FIG. 3) and may be used to designate pricing of the SAAS offerings, as a basis for an SAAS order, and auditing and compliance monitoring.

The manager 50 may also receive user SAAS selections at step 630. The user SAAS selections generally comprise information about services the users seeks to purchase or use. The user SAAS selections may also include selection of certain SAAS order elements that manager 50 may use as a basis for supplying an SAAS order that may govern the SAAS provider's SAAS offerings to the user as well as the user's use of the features provided by the manager 50.

Prior to or following steps 410 and 430, manager 50 may install or configure observer 55 at the provider 20 to communicate information regarding the provision and use of the SAAS. The observer 55 may be used to monitor the user's use of SAAS at step 640 and communicate information regarding such use to manager 50. The manager 50 may compare the user information at step 640 to track compliance with order requirements at step 650. Compliance monitoring at step 650 may also use information received from the observer 55 at the provider-end to ensure that the SAAS is being adequately supplied. Based at least in part on the user's SAAS use, the manager 50 may issue a periodic invoice at step 660 to the user on behalf of the provider. In some embodiments, the manager 50 provides a bill payment module for the user to pay the invoice. The process of FIG. 6 may the repeat to step 640 to continue monitoring SAAS use for the term of the order (or beyond).

The above described embodiments of the present invention are presented for purposes of illustration and not of limitation, and the present invention is limited only by the claims which follow.

What is claimed is:

1. A system for facilitating software as a service (SAAS), the system comprising:
a computer communicatively coupled to a network, at least one SAAS provider, and at least one SAAS user, wherein the SAAS providers comprise an observer; and wherein the computer configured to:
receive data indicating more than one SAAS offering and at least one metric associated with the SAAS offering;
receive at least one user selection indicating one of the SAAS offerings and at least one metric associated with the SAAS offerings;
monitor use, using the observer, based on the selected metric, by the user of the selected SAAS offering; and
generate a periodic invoice based at least in part on the monitored use.

2. The system of claim 1 wherein the computer is further configured to generate an order based at least on the user selection, the SAAS offering data, and the metric.

3. The system of claim 2 wherein the computer is further configured to track compliance with the order, based in part on the received data indicating the SAAS offerings and the monitored use of the SAAS.

4. The system of claim 1 wherein the computer is further configured to provide bill payment of the generated invoice.

5. The system of claim 2 wherein the computer is further configured to audit the monitored use in accordance with terms of the order.

6. The system of claim 2 wherein the computer is further configured to audit the SAAS offering in accordance with terms of the order.

7. The system of claim 1 wherein the computer is further configured to compare the monitored use with another of the SAAS offerings to determine whether the other SAAS offerings provides a service similar to the monitored use.

8. The system of claim 7 wherein if it is determined that another SAAS offering provides a service similar to the monitored use, the computer further configured to compare at least a price and a compliance history of the other SAAS offering, and present results of the determinations.

9. The system of claim 2 wherein the computer is further configured to receive a user selection indicating a change in the selected metric and update the order accordingly.

10. A method for facilitating software as a service (SAAS) comprising:
receiving data from a SAAS provider indicating more than one SAAS offering and at least one metric associated with the SAAS offering;
receiving at least one user selection indicating one of the SAAS offerings and at least one metric associated with the SAAS offerings;
monitoring use, using an observer, based on the selected metric, by the user of the selected SAAS offering; and
generating a periodic invoice based at least in part on the monitored use.

11. The method of claim 10 further comprising generating an order based at least on the user selection, the SAAS offering data, and the metric.

12. The method of claim 11 further comprising tracking compliance with the order, based in part on the received data indicating the SAAS offerings and the monitored use of the SAAS.

13. The method of claim 10 further comprising providing bill payment of the generated invoice.

14. The method of claim 11 further comprising auditing the monitored use in accordance with terms of the order.

15. The method of claim 11 further comprising auditing the SAAS offering in accordance with terms of the order.

16. The method of claim 10 further comprising comparing the monitored use with another of the SAAS offerings to determine whether the other SAAS offerings provides a service similar to the monitored use.

17. The method of claim 16 wherein if it is determined that another SAAS offering provides a service similar to the monitored use; comparing at least a price and a compliance history of the other SAAS offering, and presenting results of the determinations.

18. The method of claim 11 further comprising receiving a user selection indicating a change in the selected metric and updating the order accordingly.
